(19) United States
(12) Patent Application Publication
(10) Pub. No.: US 2021/0273931 A1
(43) Pub. Date: Sep. 2, 2021

(54) DECENTRALIZED AUTHENTICATION ANCHORED BY DECENTRALIZED IDENTIFIERS

(71) Applicant: Microsoft Technology Licensing, LLC, Redmond, WA (US)

(72) Inventors: Brandon MURDOCH, Reading (GB); Ankur PATEL, Sammamish, WA (US)

(21) Appl. No.: 16/803,407

(22) Filed: Feb. 27, 2020

(51) Int. Cl. H04L 29/06; H04L 9/32; H04W 12/06; H04L 9/06; H04L 9/30; H04L 9/00

(52) U.S. Cl. CPC H04L 63/08; H04L 9/3247; H04W 12/06; H04L 2209/38; H04L 9/30; H04L 9/006; H04L 9/0637

(57) ABSTRACT

Decentralized authentication anchored by decentralized identifiers. A user indication is received. The user indication includes selecting at least one of a plurality of authentication mechanisms. In response to a user indication, a decentralized identifier and a DID document are generated. The DID document includes at least (1) data related to the decentralized identifier and (2) data related to the selected at least one authentication mechanism. At least a portion of data contained in the DID document is then propagated onto a distributed ledger.

### BACKGROUND

Most of the currently used documents or records that prove identity are issued by centralized organizations, such as governments, schools, employers, or other service centers or regulatory organizations. These organizations often maintain every member's identity in a centralized identity management system. A centralized identity management system is a centralized information system used for organizations to manage the issued identities, their authentication, authorization, roles, and privileges. Centralized identity management systems have been deemed as secure since they often use professionally maintained hardware and software. Typically, the identity issuing organization sets the terms and requirements for registering people with the organization. Finally, when a party needs to verify another party's identity, the verifying party often needs to go through the centralized identity management system to obtain information verifying and/or authenticating the other party's identity.

Decentralized Identifiers (DIDs) are a new type of identifier, which are independent of any centralized registry, identity provider, or certificate authority. Distributed ledger technology (such as blockchain) provides the opportunity for using fully decentralized identifiers. Distributed ledger technology uses globally distributed ledgers to record transactions between two or more parties in a verifiable way. Once a transaction is recorded, the data in the section of the distributed ledger cannot be altered retroactively without the alteration of all subsequent sections of the distributed ledger, which provides a fairly secure platform. In such a decentralized environment, each owner of DID generally has control over his/her own data using his/her DID. The DID owner access the data stored in the personal storage that is associated with the DID via a DID management module, which is a mobile app (e.g., a wallet app), a personal computer, a browser, etc.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In a centralized environment, users' usernames and passwords are often stored at a credential database. When a user needs to access a centralized service, the user enters their username and password. The centralized service compares the user's input with the data stored in the credential database. If a match is found, the user is proven to be the owner of the account, and the user is allowed to access the service. If a match is not found, the user is not proven to be the owner of the account, thus, the user is denied of access to the service.

However, such a mechanism would not work for a decentralized system, because decentralized systems do not have a centralized storage to store usernames and passwords; instead, decentralized systems use distributed ledgers to record transactions. In particular, in a publicly available decentralized system, the corresponding distributed ledgers are available to the public, which cannot be used to record usernames and passwords. As such, in a decentralized environment, when a user associated with a decentralized identifier (DID) initiates a communication or transaction with another entity, it is not possible for the other entity to verify whether the user is the owner of the DID or to prove that the user has control over the DID in a similar way like that in the centralized environment. The current application aims to solve the above-mentioned problems, such that a verifying entity can authenticate whether a user initiating the transaction has control over the DID in a decentralized environment.

The principles described herein are implemented in a user's management module (e.g., a wallet application), a user agent, and/or an ID hub. A management module is referred to a mobile app or a computer app that is installed on a user's device. The user agent or an ID hub is hosted as a web service that a user has access to and can act on behalf of the user. For example, the management module is often not intended to store a whole copy of the distributed ledger, nor is the management module intended to store all the user's personal data, because the user's device often has limited storage space and also may not be connected to a computer network at all time. On the other hand, the user agent and/or the ID hub are services that can be connected to the computer network constantly and can also provide sufficient storage to store a large amount of user's personal data. Accordingly, in many embodiments, the management module is configured to securely store and manage users' DIDs and various keys, and the user agent and/or the ID hub are configured to store a complete copy (or a substantial portion) of the distributed ledger and a large amount of user's data. The user can use its management module to interact with the user agent and/or ID hub to complete transactions and to communicate with other DID owners or devices.

The embodiments described herein are related to decentralized authentications anchored by decentralized identifiers. First, the computing system (that acts as a DID owner's management module, user agent and/or ID hub) receives a user indication to generate a decentralized identifier. The user indication includes selecting at least one of multiple authentication mechanisms. In response to the user indication, a decentralized identifier (DID) and a DID document are generated. The DID document includes at least (1) data related to the decentralized identifier and (2) data related to the select at least one authentication mechanism. Next, at least a portion of data contained in the DID document is propagated to a distributed ledger.

In some embodiments, when the user initiates an action using the DID, a verifying entity receives an indication of the user's action. For example, the user's action may be a request for a service from the verifying entity. Before the verifying entity fully responds to the user's action (e.g., provides the service that the user has requested), the verifying entity often wants the user to authenticate itself, i.e., to prove that the user (who initiated the action) has control over the DID. To have the user authenticate itself, the verifying entity first accesses the distributed ledger to retrieve the authentication mechanism(s) associated with the DID. Based on the authentication mechanism(s), the verifying entity generates an authentication request and sends the request to the device of the user. In response to receiving the verifying entity's request, based on the at least one authentication mechanism, authentication data is generated.

In some embodiments, the authentication data is generated by the computing system. In some embodiments, the authentication data is generated by a second computing system of the user, and/or an authentication service. The authentication data is then caused to be sent to the verifying entity. When the verifying entity receives the authentication data, the verifying entity is caused to validate the authentication data based on the at least one authentication mechanism.

For example, in some embodiments, the at least one authentication mechanism includes a public key infrastructure (PKI). The generating the DID includes generating a private-public key pair. The public key of the key pair is recorded in the DID document and propagated onto the distributed ledger. After the verifying entity requests the user to authenticate itself, a user's device (the computing system or a second computing system of the user) generates a cryptographic signature as the authentication data that is signed by the private key of the key pair and sends the cryptographic signature to the verifying entity. The verifying entity retrieves data related to the public key from the distributed ledger and uses the public key to validate the cryptographic signature. As such, the authentication is completed in a decentralized manner without having to have a centralized service to store and verify all the users' usernames and passwords.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an example computing system in which the principles described herein is employed;

FIG. 2 illustrates an example environment for creating a decentralized identification or identifier (DID);

FIG. 3 illustrates an example environment, in which the principles described herein are implemented;

FIGS. 4A through 4C illustrate example user interfaces of a management module or a wallet app that allows the user to generate or update authentication mechanisms associated with DIDs;

FIG. 5 illustrates an example embodiment for generating or updating a DID document;

FIGS. 6A through 6C illustrate example DID documents;

FIG. 7 illustrates an example environment in which authentication of a user action is performed;

FIGS. 8A and 8B illustrate example authentication requests generated by a verifying entity;

FIGS. 9A and 9B illustrate example authentication responses generated by a device of a subject entity or an authentication service;

FIGS. 10A through 10E illustrate various example communication patterns that occur during an authentication process;

FIG. 11 illustrates a flowchart of an example method for generating a DID and a DID document based on user selection of authentication mechanism(s); and

FIG. 12 illustrates a flowchart of an example method for authenticating a user action associated with a DID based on authentication mechanism(s) associated with the DID.

### DETAILED DESCRIPTION

The embodiments described herein are related to decentralized authentications anchored by decentralized identifiers. First, the computing system (that acts as a DID owner's management module, user agent and/or ID hub) receives a user indication to generate a decentralized identifier. The user indication includes selecting at least one of multiple authentication mechanisms. In response to the user indication, a decentralized identifier (DID) and a DID document are generated. The DID document includes at least (1) data related to the decentralized identifier and (2) data related to the select at least one authentication mechanism. Next, at least a portion of data contained in the DID document is propagated to a distributed ledger.

In some embodiments, when the user initiates an action using the DID, a verifying entity receives an indication of the user's action. For example, the user's action may be a request for a service from the verifying entity. Before the verifying entity fully responds to the user's action (e.g., provides the service that the user has requested), the verifying entity often wants the user to authenticate itself, i.e., to prove that the user (who initiated the action) has control over the DID. To have the user authenticate itself, the verifying entity first accesses the distributed ledger to retrieve the authentication mechanism(s) associated with the DID. Based on the authentication mechanism(s), the verifying entity generates an authentication request and sends the request to the device of the user. In response to receiving the verifying entity's request, based on the at least one authentication mechanism, authentication data is generated and sent to the verifying entity.

In some embodiments, the authentication data is generated by the computing system. In some embodiments, the authentication data is generated by a second computing system of the user, and/or an authentication service. The authentication data is then caused to be sent to the verifying entity. When the verifying entity receives the authentication data, the verifying entity is caused to validate the authentication data based on the at least one authentication mechanism.

The multiple authentication mechanisms include, but are not limited to, (1) a public key infrastructure, (2) an authentication service, (3) a self-issued claim, or (4) a verifiable claim. When the selected at least one authentication mechanism includes a public key infrastructure. The generating the DID includes generating a key pair including a public key and a private key. The generating the DID document includes recording the public key in the DID document. The propagating at least a portion of data contained in the DID document to the distributed ledger includes recording at least data related to the public key in the distributed ledger. For example, in some embodiments, the DID and/or the public key themselves are propagated onto the distributed ledger. In some embodiments, a hash of the DID, a hash of the public key, and/or any transformation of the DID and/or the public key are propagated onto the distributed ledger, as long as the transformation can be used to prove its relationship with the DID or the public key.

When the public key infrastructure is a selected authentication mechanism, in response to a request from the verifying entity to authenticate the user action, the generating authentication data includes generating a cryptographic signature that is encrypted by the private key of the key pair as the authentication data. The cryptographic signature is then sent to the verifying entity. In some embodiments, the cryptographic key is generated by the computing system. In some embodiments, the cryptographic key is generated by a second computing system of the user.

Receiving the cryptographic key, the verifying entity is then caused to retrieve the data related to the public key via the distributed ledger and attempt to decrypt the cryptographic signature by the retrieved public key. In response to a valid decryption result, the verifying entity determines that the user's action is authenticated (i.e., the user action is proved to be initiated by the owner of the DID); and otherwise, the authentication fails.

In some embodiments, when the at least one authentication mechanism(s) includes an authentication service, the generating the DID document includes recording an address (e.g., a URL) referencing the authentication service (e.g., an endpoint of the authentication service). In some embodiments, when the at least one authentication mechanism(s) includes a self-issued claim, the generating the DID document includes recording at least one identity attribute that is required to be conveyed in the self-issued claim. In yet some other embodiments, the at least one authentication mechanism(s) includes a verifiable claim that is verifiable by a claim issuer, the generating the DID document includes recording (1) at least one identity attribute that is verifiable via the verifiable claim, and (2) an identifier of the claim issuer issuing the verifiable claim. In some cases, the identifier of the claim issuer includes a DID of the claim issuer.

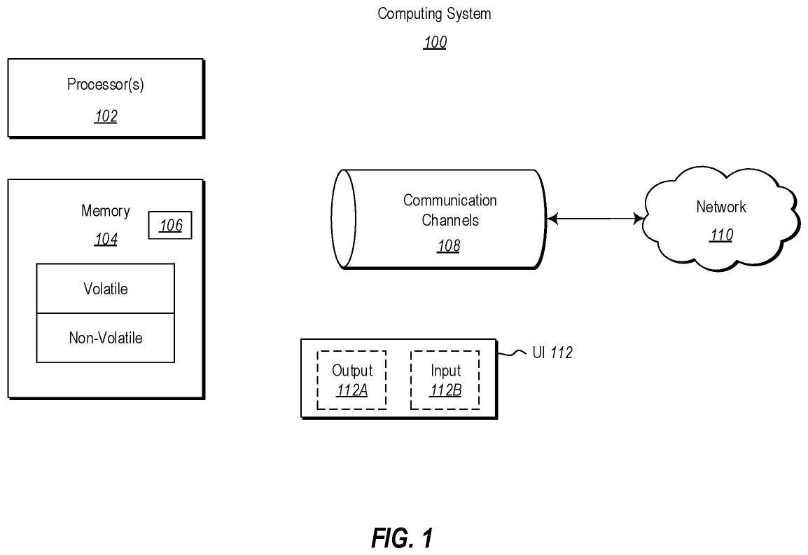

Because the principles described herein is performed in the context of a computing system, some introductory discussion of a computing system will be described with respect to FIG. 1. Then, this description will return to the principles of the DID platform with respect to the remaining figures.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that are executed by a processor. The memory takes any form and depends on the nature and form of the computing system. A computing system is distributed over a network environment and includes multiple constituent computing systems.

As illustrated in FIG. 1, in its most basic configuration, a computing system 100 typically includes at least one hardware processing unit 102 and memory 104. The processing unit 102 includes a general-purpose processor and also includes a field-programmable gate array (FPGA), an application-specific integrated circuit (ASIC), or any other specialized circuit. The memory 104 is physical system memory, which is volatile, non-volatile, or some combination of the two. The term “memory” also be used herein to refer to non-volatile mass storage such as physical storage media. If the computing system is distributed, the processing, memory and/or storage capability is distributed as well.

The computing system 100 also has thereon multiple structures often referred to as an “executable component”. For instance, memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component include software objects, routines, methods, and so forth, that is executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure is computer-readable directly by the processors (as is the case if the executable component were binary). Alternatively, the structure is structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions are embodied on one or more computer-readable media that form a computer program product. An example of such an operation involves the manipulation of data. If such acts are implemented exclusively or near-exclusively in hardware, such as within an FPGA or an ASIC, the computer-executable instructions are hardcoded or hard-wired logic gates. The computer-executable instructions (and the manipulated data) is stored in the memory 104 of the computing system 100. Computing system 100 also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 includes output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse or other pointer input, sensors of any type, and so forth.

Embodiments described herein comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions configure the computing system to perform a certain function or group of functions. The computer executable instructions are, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention is practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. In some cases, the invention also is practiced in distributed system environments where local and remote computing systems, which are linked (either by hardwired data links, wireless data links, or by a combination of hardwired and wireless data links) through a network, both perform tasks. In a distributed system environment, program modules are located in both local and remote memory storage devices.

Those skilled in the art will also appreciate that the invention is practiced in a cloud computing environment. Cloud computing environments are distributed, although this is not required. When distributed, cloud computing environments are distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures discuss various computing system which corresponds to the computing system 100 previously described. The computing systems of the remaining figures include various components or functional blocks that implement the various embodiments disclosed herein as will be explained. The various components or functional blocks are implemented on a local computing system or are implemented on a distributed computing system that includes elements resident in the cloud or that implement aspects of cloud computing. The various components or functional blocks are implemented as software, hardware, or a combination of software and hardware. The computing systems of the remaining figures include more or less than the components illustrated in the figures and some of the components are combined as circumstances warrant. Although not necessarily illustrated, the various components of the computing systems access and/or utilize a processor and memory, such as processor 102 and memory 104, as needed to perform their various functions.

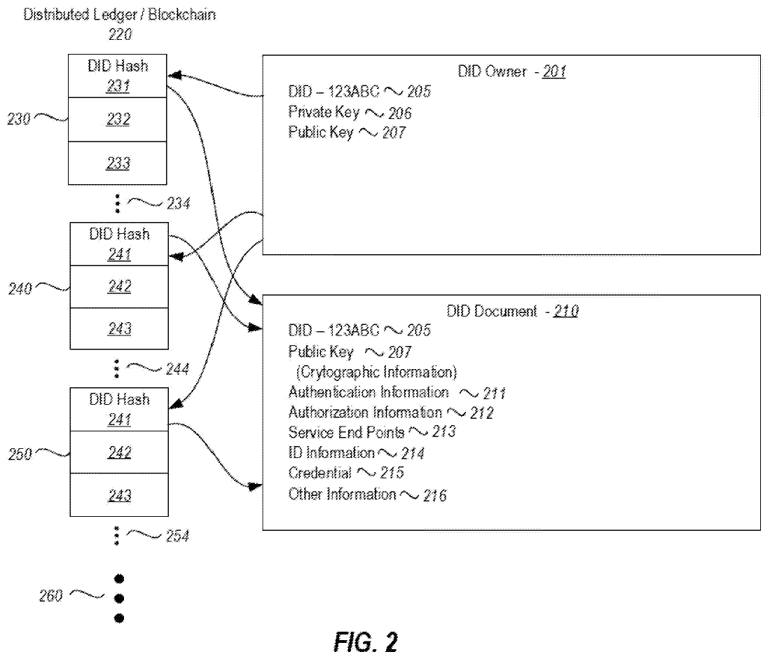

Some introductory discussions of a decentralized identification (DID) and the environment in which they are created and reside will not be given with respect to FIG. 2. As illustrated in FIG. 2, a DID owner 201 owns or controls a DID 205 that represents an identity of the DID owner 201. The DID owner 201 registers a DID using a creation and registration service, which will be explained in more detail below.

The DID owner 201 is any entity that could benefit from a DID. For example, the DID owner 201 is a human being or an organization of human beings. Such organizations might include a company, department, government, agency, or any other organization or group of organizations. Each individual human being might have a DID while the organization(s) to which each belongs might likewise have a DID.

The DID owner 201 alternatively be a machine, system, or device, or a collection of machine(s), device(s) and/or system(s). In still other embodiments, the DID owner 201 is a subpart of a machine, system or device. For instance, a device could be a printed circuit board, where the subpart of that circuit board are individual components of the circuit board. In such embodiments, the machine or device has a DID and each subpart also have a DID. A DID owner might also be a software component such as the executable component 106 described above with respect to FIG. 1. An example of a complex executable component 106 might be an artificial intelligence. An artificial intelligence also owns a DID.

Thus, the DID owner 201 is any reasonable entity, human or non-human, that is capable of creating the DID 205 or at least having the DID 205 created for and associated with them. Although the DID owner 201 is shown as having a single DID 205, this need not be the case as there is any number of DIDs associated with the DID owner 201 as circumstances warrant.

As mentioned, the DID owner 201 creates and registers the DID 205. The DID 205 is any identifier that is associated with the DID owner 201. Preferably, that identifier is unique to that DID owner 201, at least within a scope in which the DID is anticipated to be in use. As an example, the identifier is a locally unique identifier, and perhaps more desirably a globally unique identifier for identity systems anticipated to operate globally. In some embodiments, the DID 205 is a Uniform Resource Identifier (URI) (such as a Uniform Resource Locator (URL)) or other pointers that relates the DID owner 201 to mechanism to engage in trustable interactions with the DID owner 201.

The DID 205 is “decentralized” because it does not require a centralized, third party management system for generation, management, or use. Accordingly, the DID 205 remains under the control of the DID owner 201. This is different from conventional centralized IDs based trust on centralized authorities and that remain under control of the corporate directory services, certificate authorities, domain name registries, or other centralized authority (referred to collectively as “centralized authorities” herein). Accordingly, the DID 205 is any identifier that is under the control of the DID owner 201 and independent of any centralized authority.

In some embodiments, the structure of the DID 205 is as simple as a user name or some other human-understandable term. However, in other embodiments, the DID 205 preferably be a random string of numbers and letters for increased security. In one embodiment, the DID 205 is a string of 128 letters and numbers. Accordingly, the embodiments disclosed herein are not dependent on any specific implementation of the DID 205. In a very simple example, the DID 205 is shown as “123ABC”.

As also shown in FIG. 2, the DID owner 201 has control of a private key 206 and public key 207 pair that are associated with the DID 20. Because the DID 205 is independent of any centralized authority, the private key 206 should at all times be fully in control of the DID owner 201. That is, the private and public keys should be generated in a decentralized manner that ensures that they remain under the control of the DID owner 201.

As will be described in more detail to follow, the private key 206 and public key 207 pair is generated on a device controlled by the DID owner 201. The private key 206 and public key 207 pairs should not be generated on a server controlled by any centralized authority as this causes the private key 206 and public key 207 pairs to not be fully under the control of the DID owner 201 at all times. Although Figure2 and this description have described a private and public key pair, it will also be noted that other types of reasonable cryptographic information and/or mechanism also be used as circumstances warrant.

FIG. 2 also illustrates a DID document 210 that is associated with the DID 205. As will be explained in more detail to follow, the DID document 210 is generated at the time that the DID 205 is created. In its simplest form, the DID document 210 describes how to use the DID 205. Accordingly, the DID document 210 includes a reference to the DID 205, which is the DID that is described by the DID document 210. In some embodiments, the DID document 210 is implemented according to methods specified by a distributed ledger 220 that will be used to store a representation of the DID 205 as will be explained in more detail to follow. Thus, the DID document 210 has different methods depending on the specific distributed ledger.

The DID document 210 also includes the public key 207 created by the DID owner 201 or some other equivalent cryptographic information. The public key 207 is used by third-party entities that are given permission by the DID owner 201 to access information and data owned by the DID owner 201. The public key 207 also be used by verifying that the DID owner 201, in fact, owns or controls the DID 205.

The DID document 210 also includes authentication information 211. The authentication information 211 specify one or more mechanisms by which the DID owner 201 is able to prove that the DID owner 201 owns the DID 205. In other words, the mechanisms of authentication information 211 show proof of a binding between the DID 205 (and thus it's DID owner 201) and the DID document 210. In one embodiment, the authentication information 211 specifies that the public key 207 be used in a signature operation to prove the ownership of the DID 205. Alternatively or in addition, the authentication information 211 specifies that the public key 207 be used in a biometric operation to prove ownership of the DID 205. Accordingly, the authentication information 211 includes any number of mechanisms by which the DID owner 201 is able to prove that the DID owner 201 owns the DID 205.

The DID document 210 also includes authorization information 212. The authorization information 212 allows the DID owner 201 to authorize third party entities the rights to modify the DID document 210 or some part of the document without giving the third party the right to prove ownership of the DID 205. For example, the authorization information 212 allows the third party to update any designated set of one or more fields in the DID document 210 using any designated update mechanism. Alternatively, the authorization information allows the third party to limit the usages of DID 205 by the DID owner 201 for a specified time period. This is useful when the DID owner 201 is a minor child and the third party is a parent or guardian of the child. The authorization information 212 allows the parent or guardian to limit the use of the DID 205 until such time as the child is no longer a minor.

The authorization information 212 also specifies one or more mechanisms that the third party will need to follow to prove they are authorized to modify the DID document 210. In some embodiments, this mechanism is similar to those discussed previously with respect to the authentication information 211.

The DID document 210 also includes one or more service endpoints 213. A service endpoint includes a network address at which a service operates on behalf of the DID owner 201. Examples of specific services include discovery services, social networks, file storage services such as identity servers or hubs, and verifiable claim repository services. Accordingly, the service endpoints 213 operate as pointers for the services that operate on behalf of the DID owner 201. These pointers are used by the DID owner 201 or by third party entities to access the services that operate on behalf of the DID owner 201. Specific examples of service endpoints 213 will be explained in more detail to follow.

The DID document 210 further includes identification information 214. The identification information 214 includes personally identifiable information such as the name, address, occupation, family members, age, hobbies, interests, or the like of DID owner 201. Accordingly, the identification information 214 listed in the DID document 210 represents a different persona of the DID owner 201 for different purposes. For instance, a persona is pseudo-anonymous, e.g., the DID owner 201 include a pen name in the DID document when identifying him or her as a writer posting articles on a blog; a persona is fully anonymous, e.g., the DID owner 201 only want to disclose his or her job title or other background data (e.g., a school teacher, an FBI agent, an adult older than 21 years old, etc.) but not his or her name in the DID document; and a persona is specific to who the DID owner 201 is as an individual, e.g., the DID owner 201 includes information identifying him or her as a volunteer for a particular charity organization, an employee of a particular corporation, an award winner of a particular award, etc.

The DID document 210 also includes credential information 215, which also be referred to herein as an attestation. The credential information 215 is any information that is associated with the DID owner 201's background. For instance, the credential information 215 is (but not limited to) a qualification, an achievement, a government ID, a government right such as a passport or a driver's license, a digital asset provider or bank account, a university degree or other educational history, employment status and history, or any other information about the DID owner 201's background.

The DID document 210 also includes various other information 216. In some embodiments, the other information 216 includes metadata specifying when the DID document 210 was created and/or when it was last modified. In other embodiments, the other information 216 includes cryptographic proofs of the integrity of the DID document 210. In still further embodiments, the other information 216 includes additional information that is either specified by the specific method implementing the DID document or desired by the DID owner 201.

FIG. 2 also illustrates a distributed ledger or blockchain 220. The distributed ledger 220 is any decentralized, distributed network that includes various computing systems that are in communication with each other. For example, the distributed ledger 220 includes a first distributed computing system 230, a second distributed computing system 240, a third distributed computing system 250, and any number of additional distributed computing systems as illustrated by the ellipses 260. The distributed ledger or blockchain 220 operates according to any known standards or methods for distributed ledgers. Examples of conventional distributed ledgers that correspond to the distributed ledger or blockchain 220 include, but are not limited to, Bitcoin [BTC], Ethereum, and Litecoin.

In the context of DID 205, the distributed ledger or blockchain 220 is used to store a representation of the DID 205 that points to the DID document 210. In some embodiments, the DID document 210 is stored on the actually distributed ledger. Alternatively, in other embodiments the DID document 210is stored in a data storage (not illustrated) that is associated with the distributed ledger or blockchain 220.

As mentioned, a representation of the DID 205 is stored on each distributed computing system of the distributed ledger or blockchain 220. For example, in FIG. 2 this is shown as the DID has 231, DID has 241, and DID has 251, which are ideally identical copies of the same DID. The DID hash 231, DID hash 241, and DID hash 251 then point to the location of the DID document 210. The distributed ledger or blockchain 220 also store numerous other representations of other DIDs as illustrated by references 232, 233, 234, 242, 243, 244, 252, 253, and 254.

In one embodiment, when the DID owner 201 creates the DID 205 and the associated DID document 210, the DID has 231, DID has 241, and DID hash 251 are written to the distributed ledger or blockchain 220. The distributed ledger or blockchain 220 thus records that the DID 205 now exists. Since the distributed ledger or blockchain 220 is decentralized, the DID 205 is not under the control of any entity outside of the DID owner 201. The DID hash 231, DID has 241, and DID has 251 includes, in addition to the pointer to the DID document 210, a record or timestamp that specifies when the DID 205 was created. At a later date when modifications are made to the DID document 210, this also is recorded in DID has 231, DID has 241, and DID has 251. The DID has 231, DID has 241, and DID hash 251 further includes a copy of the public key 207 so that the DID 205 is cryptographically bound to the DID document 210.

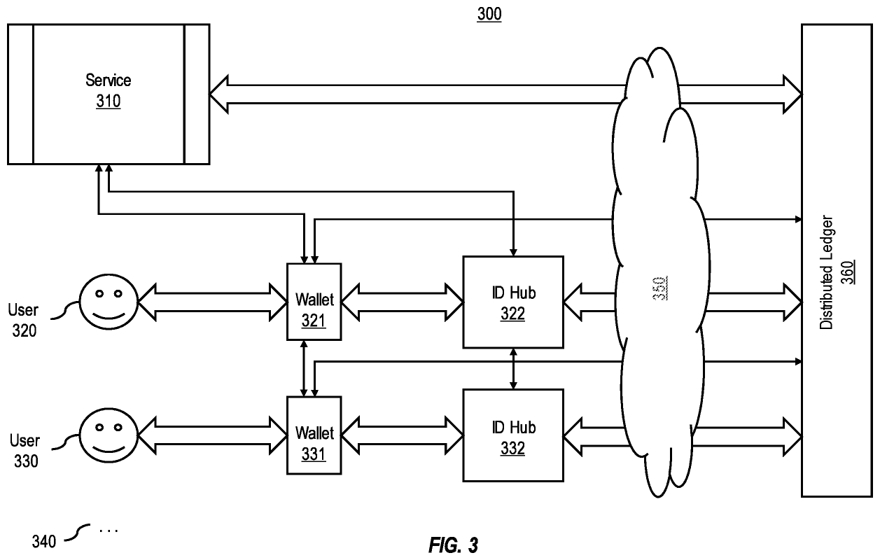

Having described DIDs and how they operate generally with reference to FIG. 2, specific embodiments of decentralized authentication will now be explained. Turning to FIG. 3, a decentralized environment 300 that allows DID owners to access services and perform transactions with other DID owners while authenticating themselves will now be explained. It will be appreciated that the environment of FIG. 3 reference elements from FIG. 2 as needed for ease of explanation.

As illustrated in FIG. 3, the decentralized environment 300 includes a device associated with a service provider 310 and wallet apps 321 and 311 of users 320, 330. The ellipsis 340 represents that there may be any number of devices associated with any number of service providers and/or users in the decentralized environment 300. Each of the service provider(s) and users 320, 330 corresponds to a DID owner 201 of FIG. 2. Each of the devices 310 and wallet apps 321, 331 has access to the distributed ledger via a computer network 350.

User 320 uses a wallet app 321 to manage his/her DIDs, and user 330 uses a wallet app 331 to manage his/her DIDs. The wallet app 321 or 331 is connected to a respective ID hub 322 or 332. Each of wallets 321, 331 and/or ID hubs 322, 332 has access to a distributed ledger 360 via a computer network 350. In some embodiments, the wallet app 321 or 331 has indirect access to the distributed ledger via the ID hub 322 or 332. In some embodiments, the wallet app 321 or 331 is configured to store a complete copy of the distributed ledger or has direct access to the distributed ledger via the computer network 350. The device of the service provider 310 and each wallet apps 321, 331 and/or ID hubs 322, 332 are capable of communicating with each other via various communication channels, including, but not limited to, local area network, a wide area network, a BLE beacon signal, and/or near field communication (NFC). The communication can also be performed via generating a bar code or a QR code that by one wallet app 321, and scanning the bar code or a QR code by another wallet app 331 or the device of the service provider 310. The barcode or the QR code includes the identification information related to the user 320, such as the DID associated with the user 320.

In some embodiments, the user 320 can request for accessing a service provided by the service provider 310 via the wallet app 321. In the request, the wallet app 321 may or may not include the user's identification information (e.g., the user's DID). When the request does not include the user's identification information, the service 310 will likely request the user's wallet app 321 to provide such information. Subsequently, the wallet app 321 will then send the user's DID and/or authentication data to the service 310. In some embodiments, to further verify that the user is the true owner of the DID or the device that installs the wallet app 321, the wallet app 321 further requires the user to enter some input to prove that the user is the true owner of the device. For example, in some cases, a device password and/or biometric data (including, but not limited to fingerprint and irises scan) are required to be entered by the user before the wallet app 321 generates the authentication data. Once the service 310 receives the DID and the authentication data, the service 310 then retrieves relevant data related to the DID from the distributed ledger, and uses the retrieved data to validate the authentication data received from the wallet app 321.

A similar process can also occur between two users' wallets 321, 322 to allow the two users 320 and 330 to communicate or conduct transactions with each other. For example, a communication or a transaction can be initiated by wallet app 321 and transmitted to wallet app 331. When the wallet app 331 receives the DID of the user 320, the wallet app 311 will access the distributed ledger to retrieve the authentication mechanism(s) associated with the DID. Based on the retrieved authentication mechanism(s), the wallet app 331 generates and sends an authentication request to wallet app 321. Receiving the authentication request, wallet app 321 then generates and sends its authentication data back to wallet app 331. Wallet app 331 then authenticates the validity of the authentication data.

Various authentication mechanisms may be implemented in decentralized systems. The various authentication mechanisms include, but are not limited to, using public key infrastructure (PKI), using authentication service(s), using self-issued claim(s), and/or using verifiable claim(s). In some cases, the users are allowed to select which authentication mechanism(s) are to be implemented for their DIDs. In some cases, the service provider or the DID methods are allowed to select or define which authentication mechanism(s) are required for users to use their services.

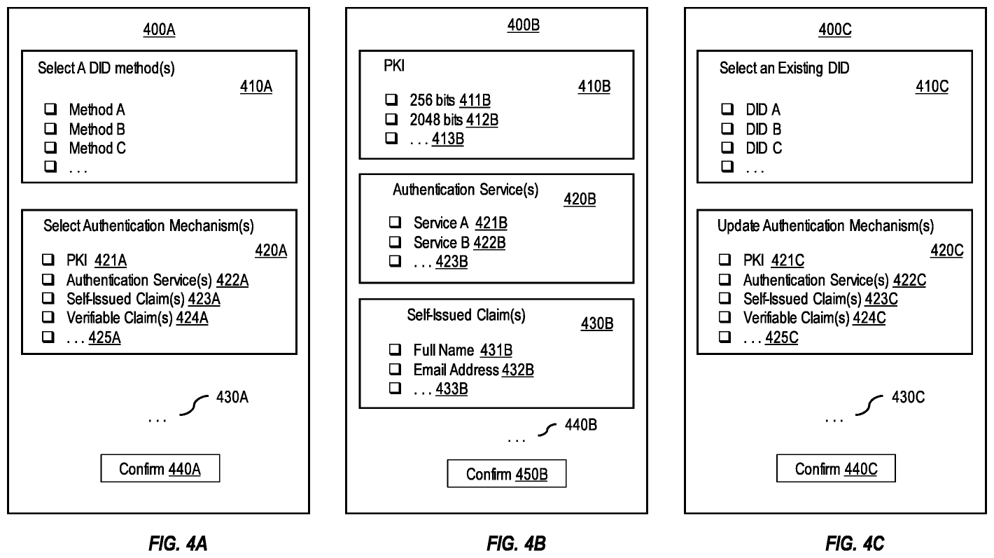

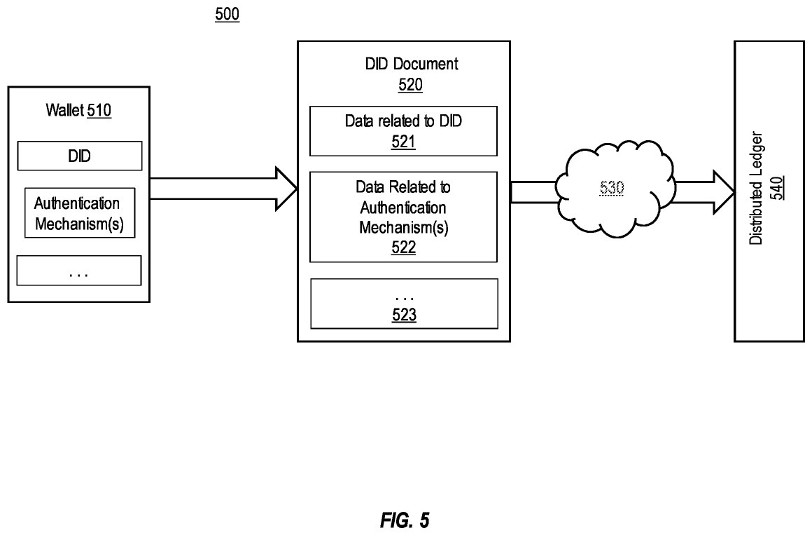

In some embodiments, when a user is to generate a new DID, the wallet app, user agent, and/or ID hub provides a user with various options that the user can select. FIGS. 4A through 4C illustrate example user interfaces 400A through 400C of a user's wallet app, user agent, and/or ID hub, which corresponds to the wallet app 321, 331 of FIG. 3. As illustrated in FIG. 4A, the user interface 400A includes a DID methods menu 410A that allows a user to select various DID methods. The DID method defines how and where the DID can be found. For example, Bitcoin, Ethereum, Sovrin, IPFS, and Veres One are examples of existing DID methods.

The user interface 400A also includes an authentication mechanism menu 420A that allows a user to select various authentication mechanisms, such as PKI 421A, authentication services 422A, self-issued claims 423A, and/or verifiable claims 424A. The ellipsis 425A represents that there may be any number of authentication mechanisms that the user can select from. The ellipsis 430A represents that the user interface 400A may include any number of visualizations or fields, through which the user can input additional information related to the to be generated DID.

Once the user selects one or more particular authentication mechanisms, in some embodiments, additional user interface(s) are populated for the user to further specify each selected authentication mechanisms. FIG. 4B illustrates such an example user interface 400B that includes a separate input field for each of the selected authentication mechanism(s). Assuming that the user has selected PKI 421A, authentication service(s) 422A, and self-issued claims 423A via the user interface 400A. After the user presses the confirm button 440A, the wallet app presents the user with a next user interface 400B, including a PKI input field 410B, an authentication service(s) input field 420B, and a self-issued claim(s) input field 430B, each of which allows the user to input additional information related to these authentication mechanisms.

As illustrated in FIG. 4B, the PKI input field 410B allows the user to select a length of the key that the user desires. For example, the user can select 256 bits 411B or 2048 bits 412B as the length of the keys. In general, the longer the key, the more secure the encryption. The ellipsis 413B represents that there may be additional options that the user can select. Alternatively, or in addition, the user may be allowed to enter a particular number or additional preference related to the keys.

The authentication service(s) input field 420B allows the user to select or input one or more authentication service providers. For example, the user can select service A 421B and/or service B 422B as authentication services that are to be used to authenticate the user's identity. The self-issued claim(s) input field 420B allows the user to select or input the attributes that are to be included in the self-issued claim(s). For example, the user can select or define that his/her full name 431B and/or email address 432B are to be included in the self-issued claims that are to be issued during the authentication process. The ellipsis 423B and 433B represent that any number of choices may be provided to the user. Alternatively, or in addition, the user may be allowed to manually input additional information related to the corresponding authentication mechanisms.

Further, a user should also be allowed to modify or update previously selected authentication mechanisms. FIG. 4C illustrates an example user interface 400C that allows a user to update authentication mechanisms of existing DIDs. As illustrated in FIG. 4C, the user interface 400C includes an existing DID menu 410C, through which a user can select an existing DID that the user wants to modify. The user interface 400C also includes an update authentication mechanism(s) menu 420C, through which the user can update the previous selections of one or more authentication mechanisms. Once the user clicks the confirm button 440C, the user may then be brought to another user interface (e.g., user interface 400B) that allows the user to further input additional details about the selected authentication mechanisms.

FIGS. 4A through 4C are merely some examples of how a user may be allowed to implement various authentication mechanisms for their own DIDs. The service providers and DID methods can also define or require particular authentication mechanisms. In such a case, the wallet app may cause the user interfaces 400A through 400C to gray out the authentication mechanisms that the DID method does not accept. Alternatively, or in addition, the wallet app may automatically select the authentication mechanisms that the DID method accepts for the user.

Once the authentication mechanisms for the user's DID is selected and defined, the user's wallet app (or agent or ID hub) is triggered to generate or update a DID and its corresponding DID document. FIG. 5 illustrates an example embodiment 500 that is implemented by a wallet app 510 that corresponds to the wallet app 321 or 331 of FIG. 3. In response to a user indication to generate a new DID or modify an existing DID, the wallet app 510 generates or updates the corresponding DID document 520. The DID document 520 includes at least data related to the DID 521 and data related to the selected authentication mechanism(s) 522. The ellipsis 523 represents that there may be additional information record in the DID document 520 depending on the DID methods and the services that the user intended to use. Thereafter, at least a portion of the data contained in the DID document 520 is propagated onto the distributed ledger 540 via a computer network 530.

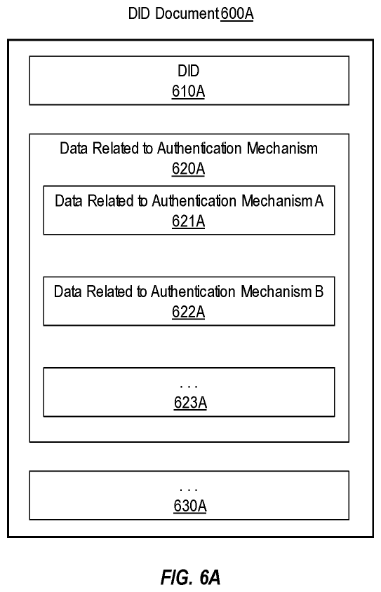

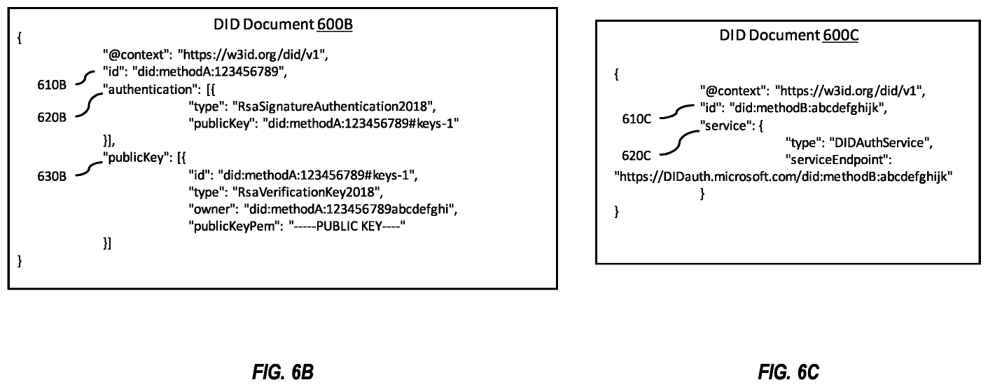

As previously described with respect to FIG. 2, a DID document is used to record a set of data describing the DID subject (i.e., a DID owner 201). FIGS. 6A through 6C further illustrates example DID documents. FIG. 6A illustrates an example structure of a DID document 600A. The DID document 600A includes a DID 610A that is associated with the subject. The DID document 600A also includes data related to the authentication mechanism(s) 620A that are used to authenticate the user. When there are multiple authentication mechanisms are selected, a separate set of data related to each selected authentication mechanism is recorded in the DID document. For example, when authentication mechanisms A and B are both selected, the DID document 600A would include data related to authentication mechanism A 621A and data related to authentication mechanism B 622A. The ellipsis 623A represents that there may be any sets of data associated with any number of selected authentication mechanisms recorded in the DID document 600A. The ellipsis 630 A represents that there may be additional data related to the DID subject that is recorded in the DID document 600A.

FIGS. 6B and 6C further illustrate two example DID documents 600B and 600C that are written in a graph-based data format (e.g., JSON-LD format). FIG. 6B illustrates a DID document 600B, which indicates that the authentication mechanism is RSA signature authentication 2018, which is a particular PKI type. The DID document 600B includes data 610B related to the DID and data 620B and 630B related to the selected authentication mechanism. Based on the data 610B related to the DID, it is understood that the DID method is “methodA”, and the DID is “123456789.” Based on the data 620B related to the selected authentication mechanism, it is understood that the selected authentication mechanism is “RsaSignatureAuthentication2018”, which is a particular PKI type. As such, a private-public key pair is generated for such an authentication mechanism. The private-public key pair is then linked to the DID 123456789, and the data related to the public key is then recorded as 630B in the DID document 600B. Note, only data related to the public key is recorded in the DID document 600B and propagated onto the distributed ledger. The private key will be kept secret at all times. Various methods may be implemented to securely store the private key. For example, in some embodiments, the private key is encrypted by a user's passcode of a user device, and stored at the device that installs the wallet app.

FIG. 6C illustrates another example DID document 600C, which indicates that the authentication mechanism is an authentication service. The DID document 600C also includes data 610C related to the DID and data 620C related to the selected authentication mechanism. Here, based on the data 610C related to the DID, it is understood that the DID method is “methodB”, and the DID is “abcdefghijk.” Based on the data 620C related to the authentication mechanism, it is understood that the selected authentication mechanism is “DIDAuthService”, which is provided via a service endpoint at “https: //DIDauth.microsoft.com/did:methodB:abcdefghijk.”

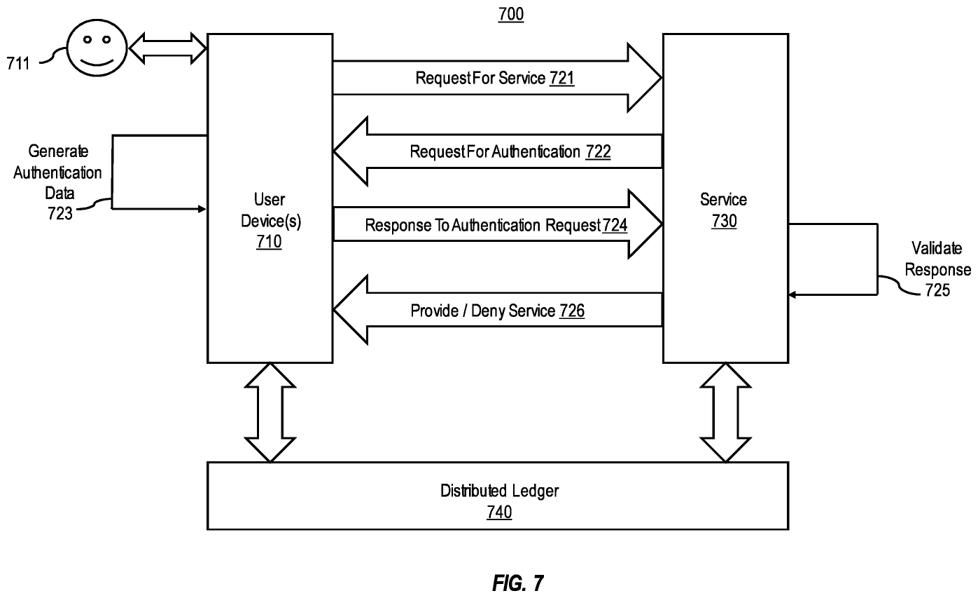

FIG. 7 further illustrates example environment 700, in which authentication of a user action is performed. In environment 700, a user 711 has control over one or more devices 710. The user first requests for a service from a service provider 730, which is represented by arrow 721. Such a request may be initiated via a website of the service 730. Alternatively, or in addition, such a request may also be initiated by directly communicating with a device associated with the service 730, including, but not limited to, using ad hoc WIFI, BLE beacon, scanning a barcode, and/or NFC. The request may or may not include the identity information of the user.

When the service provider 730 receives the request, the service provider 730 would want to know the identity of the user and also want to verify that the person who has initiated the request is truly associated with the identity being presented. As such, the service provider 730 would want to request the user 711 to present his/her identity and to authenticate the identity being presented, which is represented by arrow 722. In some cases, if the service provider 730 already received the DID associated with the user 711, the service provider 730 goes to the distributed ledger to retrieve the authentication mechanism(s) associated with the DID. When there are more than one authentication mechanism available, the service provider 730 selects one or more preferred authentication mechanisms amongst the available mechanisms and generates the authentication request based on the preferred authentication mechanism(s).

Receiving the request for authentication, the user's device 710 will present its DID and also generate authentication data based on the authentication request 722 and based on authentication mechanism(s) associated with the DID, which is represented by arrow 723. For example, if PKI is used as the authentication mechanism, a cryptographic signature will be generated by the user device 710. The cryptographic signature is encrypted by a private key of the DID.

In some embodiments, the cryptographic signature can be generated by a wallet app. In some embodiments, the user's browser can install a DID management addon model, and the cryptographic signature can be generated by the user's browser directly. In some cases, before generating the authentication data, at least one of the user device(s) 710 is required to further verify the user via a passcode and/or biometric information. For example, the user may be required to enter a passcode and/or scan his/her fingerprint or iris at a mobile device before the authentication data is generated.

The generated authentication data is then sent to the service provider 730, which is represented by arrow 724. Receiving the authentication data, the service provider 730 will then validate the authentication data, which is represented by arrow 725. For example, in some cases, if a PKI is used as the authentication mechanism, and a cryptographic signature is received by the service provider 730, the service provider 730 will retrieve the public key of the DID from the distributed ledger 740, and use the retrieved public key to try to decrypt the cryptographic signature. If the cryptographic signature is properly decrypted, the service provider 730 determines that the user's identity has been authenticated, otherwise, the user's identity is not authenticated.

In some embodiments, a hash of the public key is propagated onto the distributed ledger. In such a case, the authentication data would not only include a cryptographic signature, but also include the public key. The service provider 730 will retrieve the hash recorded on the distributed ledger, use the received public key to verify that the public key corresponds to the hash, and then use the received public key to verify that the cryptographic signature is valid.

Once the validation is completed, the service provider 730 will often provide or deny the service request of the user, which is represented by arrow 726. For example, the user is trying to access his/her cloud storage. When the user's identity has been successfully validated, the service provider 730 will grant the user access to his/her cloud storage. As another example, the user is trying to rent a car. When the user's identity has been successfully validated, the service provider 730 will give a key of a rental car to the user.

The above-described scenario is just one example of authenticating a user's identity by a service provider. Similar authentication mechanisms can also be used between two wallet apps of users. In such a case, service 730 is replaced by another user's device. Further, in many cases, the two parties are mutually both a verifying entity and a verifying entity. For example, not only one DID owner wants to authenticate the user of another DID owner; the other DID owner also wants to authenticate the first DID owner. In such a case, additional mirroring communications would occur from the opposite direction as illustrated in FIG. 7.

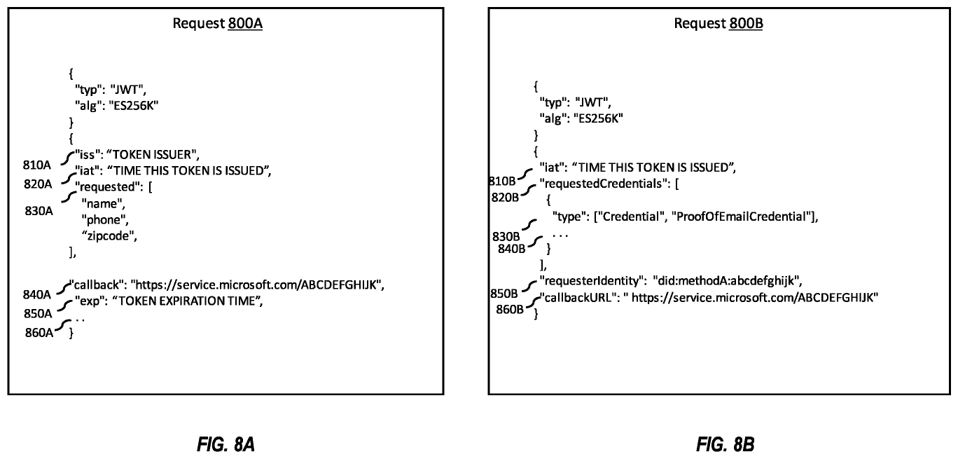

As briefly discussed above, a verifying entity (e.g., the service provider 730) can retrieve the available authentication mechanism(s) associated with a particular DID from the distributed ledger, and tailor its authentication request based on the available authentication mechanism(s). FIGS. 8A and 8B illustrate two example authentication requests that are tailored to particular authentication mechanism(s), which are both written as JSON Web Token (JWT) format.

FIG. 8A illustrates a request token 800A that is issued by a verifying entity, which corresponds to the service provider 730 of FIG. 7. In this token 800A, the token issuer (i.e., the verifying entity) requests the subject entity (i.e., the DID owner) to provide his/her name, phone number, and zipcode (with or without any authentication requirement). The authentication request token 800A includes data 810A, indicating the token issuer, and data 820, indicating the token issue time. The authentication request token 800 also includes data 830A, which indicates that the verifying entity requests the subject entity to provide his/her “name”, “phone”, and “zipcode”. The request token 800A also includes a callback address “https: //service.microsoft.com/ABCDEFGHIJK” 840A, which is a URL, where the DID owner is requested to send its response to. Finally, there is also an expiration time 850 indicating an expiration time for the request token 800A, as such, the DID owner must response to the request token 800A before the expiration time. The ellipsis 860A represents that the request token 800A may also include additional data related to the token issuer, the DID owner, or the authentication mechanism.

FIG. 8B illustrates another example authentication request token 800B, in which the verifying entity requires the authentication be performed via a verifiable claim. As illustrated in FIG. 8B, the request token 800B includes data 810B indicating the time the token 800B was issued. The request token 800B also includes data 820B indicating the requested verifiable credentials. Here, the type of the required verifiable credential is email credential 830B, i.e., the verifying entity requires the DID owner to provide and proof his/her email address. The ellipsis 840B represents that there may be additional data included in the requested credential field 820B that further specifies the requirement of the verifiable email address. The request token 800B further includes the requester's identity 850B, which is the DID of the verifying entity. Finally, the request token 800B also includes a callback address “https: //service.microsoft.com/ABCDEFGHIJK” 860B, which is a URL, where the authentication service is requested to send its response to.

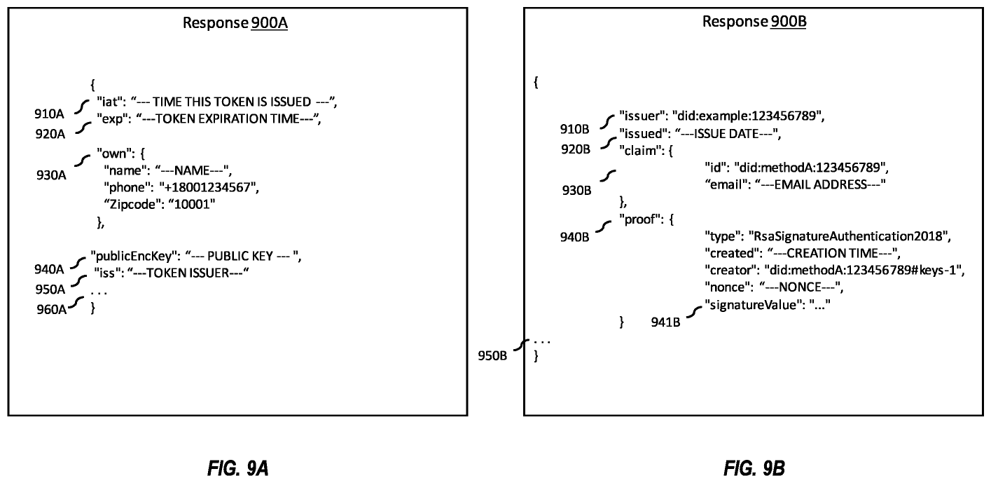

Receiving the authentication request token, a device associated with the DID (e.g., user device 710) will tailor its response based on the authentication request and the available authentication mechanism(s). FIGS. 9A and 9B illustrate two example authentication responses that are generated by a DID subject (e.g., user device(s) 710 and/or the user's wallet app 321, 322).

FIG. 9A illustrates a response token 900A that corresponds to the request token 800A. The response token 900A includes data 910A that indicates the time this token 900A is issued. The response token 900A also includes data 920 indicating the expiration time of the token 900A. Further, the response token 900A also includes a statement 930 stating the DID subject's name, phone number and zipcode as requested by the request token 800A. Further, the response token 900A also includes a public key 940A and the token issuer 950A. Here, the token issuer is the DID owner (e.g., user 711). The public key 940A is associated with the DID owner. The ellipsis 960A represents that there may be additional data included in the response token 900A, such as a cryptographic signature signed by a private key of the DID subject. This response token 900A will be sent to the callback URL “https://service.microsoft.com/ABCDEFGHIJK” 840A included in the request token 800A, such that when the verifying entity receives this response token 900A, it is understood that this response token 900A is intended to response to the request token 800A.

FIG. 9B illustrates another example response token 900B that corresponds to the request token 800B. The response token 900B includes data 910B indicating the issuer of a verifiable claim and data 920B indicating the time the claim was issued. The response token 900B also includes the claim 930B, which includes the claimed matter and a proof. The proof includes a signature that is signed by a private key of the claim issuer 910b, such that when the verifying entity receives the response, it can retrieve the data related to the public key of the claim issuer and validate the signature using the data related to the public key. The response token 900B will be sent back to the callback URL 860B of the request token 800B.

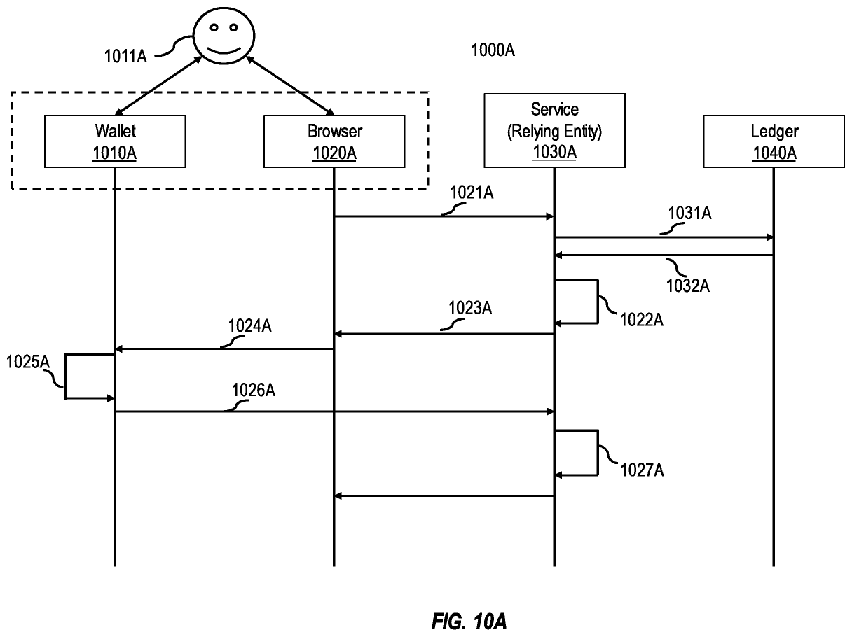

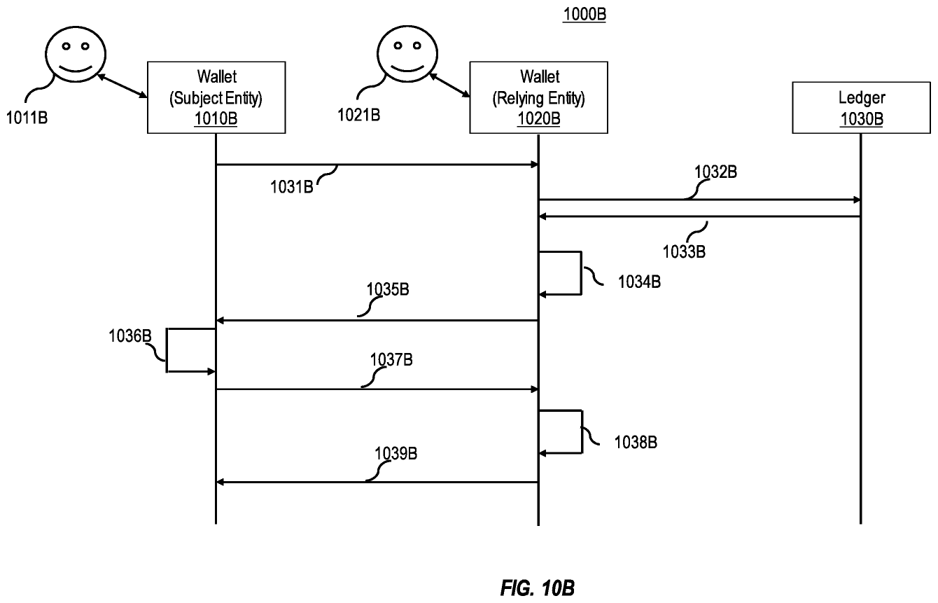

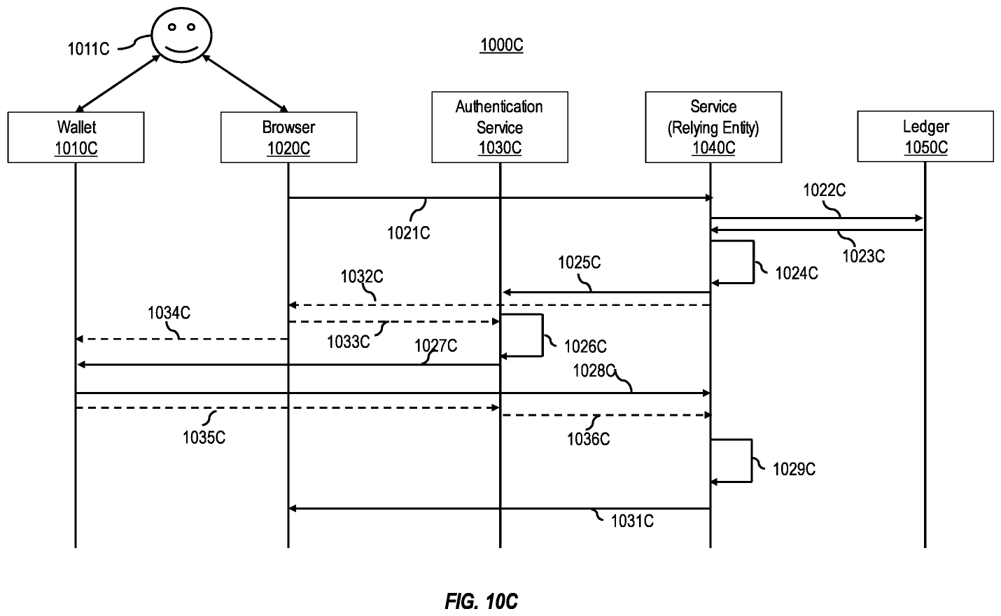

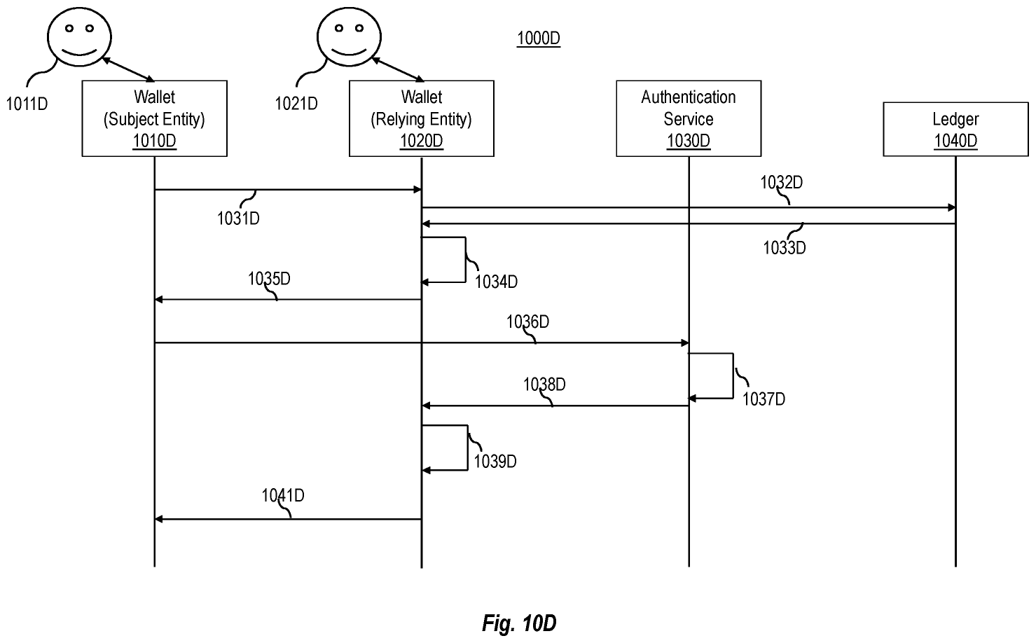

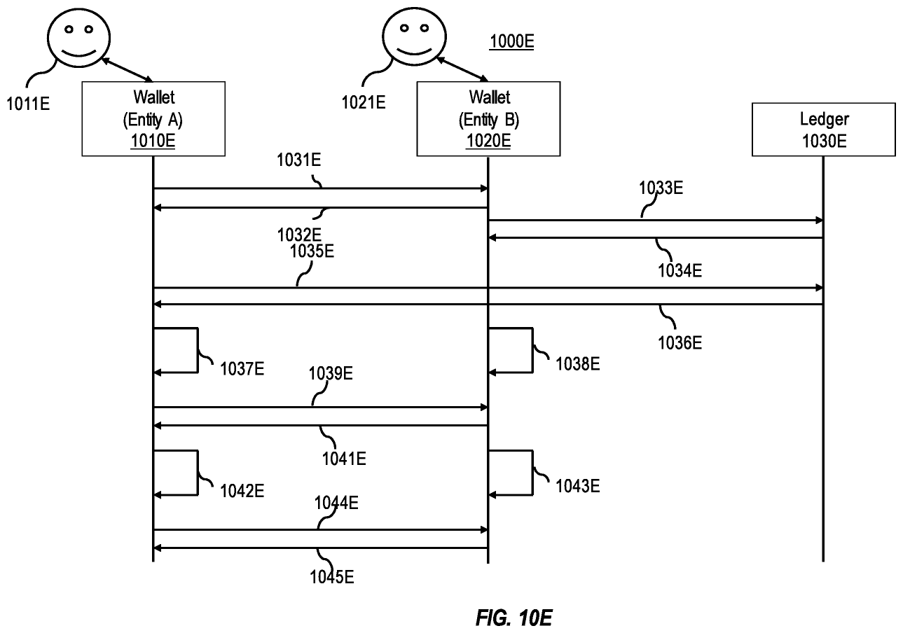

In the process of authentication, various communication patterns may be implemented to achieve the authentication goal. FIGS. 10A through 10E illustrate several example communication patterns that may occur in the process of authentication. FIG. 10A illustrates an example communication pattern 1000A that occurs between a DID owner 1011A and a service provider 1030A. In this case, the service provider 1030A is a verifying entity. As illustrated in FIG. 10A, the user 1011A is requesting a service from the service provider's web page via a browser 1020A, which is represented by arrow 1021A. It is assumed that the request includes the user's DID. In response to the service request 1021A, the service provider 1030A accesses a distributed ledger 1040A to retrieve the data related to the authentication mechanism(s) associated with the DID, which is represented by arrows 1031A and 1032A.

Based on the retrieved data related to the authentication mechanism(s), the service provider 1030A generates an authentication request (corresponding to the example authentication request tokens 800A, 800B of FIG. 8A or 8B), which is represented by arrow 1022A. The generated authentication request is sent to the user's browser 1020A, which is represented by arrow 1024A. Receiving the authentication request from the service provider 1030A, the user's browser 1020A passes on the authentication request to the user's wallet app 1010A, which is represented by arrow 1024A.

In some cases, when the user's browser 1020A and the user's wallet app 1010A reside on the same device, such communication occurs automatically and internally between the browser and the wallet app. Alternatively, when the user's browser 1020A and the wallet app 1010A reside on different devices, the user's browser 1020A may display a bar code or a QR code that is configured for the user's wallet app 1010A to scan. The barcode or the QR code includes at least a portion of data included in the authentication request received from the service provider 1030A. The user 1011A then uses his/her wallet app 1010A to scan the bar code or QR code displayed on the browser 1020A. As such, the authentication request is transmitted from the browser 1020A to the wallet app 1010A via a barcode or QR code. Such communication can also be completed via ad hoc WIFI, BLE beacon, and/or NFC.

Next, based on the received authentication request, the wallet app 1010A generates authentication data for responding to the authentication request, which is represented by arrow 1025A. The generated authentication data is then packaged in a response and sent back to the service provider 1030A, which is represented by arrow 1026A. Receiving the response including the authentication data from the wallet app 1010A, the service provider 1030A then validates the authentication data, which is represented by arrow 1027A. In response to the validation, the service provider 1030A will grant or deny the service request of the user 1011A.

FIG. 10B illustrates another communication pattern 1000B, which occurs between two users' wallet apps 1010B and 1020B. As illustrated in FIG. 10B, a user 1011B has control over a wallet app 1010B, and a user 1021B has control over a wallet app 1020B. Here, user 1011B is a subject entity, and user 1020B is a verifying entity. For example, user 1011B may be a contractor, and user 1020B may be a homeowner that is looking for a contractor to remodel his/her kitchen. When the contractor (i.e., subject entity) 1011B meets the homeowner (i.e., verifying entity) 1020B, the homeowner 1020B would like to verify the identity of the contractor 1010B.

First, the contractor 1011B will provide his/her DID to the homeowner 1020B via their wallet apps 1010B and 1020B, which is represented by arrow 1031B. The homeowner's wallet app 1020B then accesses the distributed ledger 1030B to obtain data related to the authentication mechanisms, which is represented by arrows 1032B and 1033B. Based on the received authentication data, the homeowner's wallet app 1020B generates an authentication request, which is represented by arrow 1034B. The authentication request is then sent from the homeowner's wallet app 1020B to the contractor's wallet app 1010B, which is represented by arrow 1035B. Receiving the authentication request, the contractor's wallet app 1010B then generates corresponding authentication data and package the authentication data in a response, which is represented by arrow 1036B. The response is then sent from the contractor's wallet app 1010B to the homeowner's wallet app 1020B, which is represented by arrow 1037B. Receiving the response including the authentication data, the homeowner's wallet app 1020B then validates the authentication data, which is represented by arrow 1038B. Based on the validation result, the homeowner's wallet app 1020B then sends a response to the contractor's wallet app 1010B, which is represented by arrow 1039B. For example, when the validation is successful, the homeowner 1021B can use his/her wallet app 1020B to initiate additional transactions with the contractor's wallet app 1010B, such as signing a contract or making a payment.

The communications between the wallet apps 1010B and 1020B may be performed via any available communication channels, including but not limited to, web servers, ad hoc WIFI, BLE beacon signal, NFC, a barcode or QR code scanning, etc.

FIG. 10C illustrates yet another communication pattern 1000C that occurs amongst a user 1011C, an authentication service 1030C, and a service provider 1040C. The solid line arrows represent communication patterns in one embodiment, and the dotted arrows represent the alternative communication patterns that may occur in other alternative embodiments.

First, the user 1011C requests a service or initiates a communication via a web page of the service provider 1040C from the browser 1020C, which is represented by arrow 1021C. The request includes a DID of the user 1011C. Receiving the request, the service provider 1040C accesses a distributed ledger 1050C to retrieve one or more authentication mechanism(s) associated with the DID, which is represented by arrows 1022C and 1023C. Based on the retrieved authentication mechanisms(s), the service provider 1040C generates an authentication request, which is represented by arrow 1024C.

Here, the at least one of the retrieved authentication mechanism(s) is via the authentication service 1030C. As such, in some embodiments, the generated authentication request is sent to the authentication service 1030C directly, which is represented by arrow 1025C. Receiving the authentication request from the service provider, the authentication service 1030C then generates the authentication data, which is represented by arrow 1026C. The authentication data generated by the authentication service 1030C is then sent to the user's wallet app 1010C, which is represented by arrow 1027C. The user's wallet app 1010C then, in turn, passes on the authentication data to the service provider 1040C, which is represented by arrow 1028C. Receiving the authentication data, the service provider 1040C then validates the authentication data, which is represented by arrow 1029C, and responds back to the user's browser 1020C, which is represented by arrow 1031C.

Alternatively, in some embodiments, after the service provider 1040C generates an authentication request (represented by arrow 1024C), the service provider 1040C sends the authentication requests to the browser 1020C, which is represented by dotted arrow 1032C. The browser 1032C can either pass on the authentication request to the authentication service 1030C (represented by dotted arrow 1033C) or to the wallet app 1010C (represented by dotted arrow 1034C).

Further, after the authentication service 1030C generates the authentication data (represented by arrows 1026C), in some embodiments, the authentication service 1030C merely contacts the wallet app 1010C to notify the user the receipt of the authentication request and to obtain the user's consent (represented by arrow 1027C). When the user's wallet app 1010C receives the notification, the wallet app 1010C consents and sends the consent back to the authentication service, which is represented by dotted arrow 1035C. Receiving the user's consent, the authentication service 1030C then sends the authentication data directly to the service provider 1040C, which is represented by dotted arrow 1036C.

FIG. 10D illustrates another communication pattern that occurs amongst two users wallets 1010D, 1020D, and an authentication service 1030D. Similar to the scenario of FIG. 10B, the user 1011D may be a contractor, and user 1021D may be a homeowner who hires the contract to remodel his/her kitchen. The contractor 1011D has control over a wallet app 1010D, and the homeowner 1020D has control over a wallet app 1020D. First, the contractor's wallet app 1010D sends the homeowner's wallet app 1020D the contractor's DID, which is represented by arrow 1031D. Receiving the DID of the contractor, the homeowner's wallet app1020D then accesses the distributed ledger 1040D to obtain data related to one or more authentication mechanism(s) that are associated with the DID, which is represented by arrows 1022D and 1023D.

Based on the retrieved one or more authentication mechanism(s), the homeowner's wallet app 1020D then generates an authentication request (represented by arrow 1034D). The authentication request is then sent to the contractor's wallet app 1010D (represented by arrow 1035D). Receiving the authentication request, the contractor's wallet app 1010D then passes on the authentication request to the authentication service 1030D (represented by arrow 1036D). Based on the authentication request, the authentication service then generates authentication data (represented by arrow 1037D). The generated authentication data is then sent to the homeowner's wallet app 1020D (represented by arrow 1038D). The homeowner's wallet app 1020D then validates the authentication data (represented by arrow 1039D). Based on the validation result, the homeowner's wallet app 1020D then further communicates with the contractor's wallet app 1010D (represented by arrow 1041D).

Similar to the alternative embodiments illustrated in FIG. 10C, the communications amongst wallet app 1010D, 1020D, and authentication service 1030D may also occur in different patterns. For example, the authentication service 1030D can also send authentication data to the subject entity's wallet app 1010D, and have the subject entity's wallet app 1010D pass on the authentication data to the verifying entity's wallet app 1020D.

Finally, in many transactions, the authentication is mutually performed by both parties. In such a case, each involved party is both a subject entity and a verifying entity. FIG. 10E illustrates a communication pattern 1000E that occurs in a mutual authentication situation. As illustrated in FIG. 10E, a first user 1011E has control over a wallet app 1010E, and a second user 1021E has control over a wallet app 1020E. At the beginning, wallets 1010E and 1020E exchange each other's DIDs, which is represented by arrows 1031E and 1032E. Next, each of the wallets 1010E and 1020E accesses a distributed ledger to obtain each other's authentication method(s), which is represented by arrows 1033E, 1034E, 1035E, and 1036E. Each of wallets 1010E and 1020E then generates its own authentication request based on the other DID's authentication method(s), which is represented by arrows 1037E and 1038E. The generated authentication data is then sent to the other entity's wallet, which is represented by arrows 1039E and 1041E. Receiving each other's authentication data, each of wallet apps 1010E and 1020E validates the received authentication data (represented by arrows 1042E and 1043E). Based on the validation results, the wallets 1010E and 1020E may then perform additional communications (represented by arrows 1044E and 1045E).

Please note, in FIGS. 10A through 10E, all the communications performed by wallet apps can also be performed by ID hubs and/or user agents. In some embodiments, ID hubs and/or user agents are configured to perform complete or at least a portion of the communications in the process of authentication. Thus, the wallet apps illustrated in FIGS. 10A through 10E does not intend to limit the scope of the embodiments to be performed by merely wallet apps, and each of the illustrated wallet apps can be replaced by a management module, an ID hub and/or a user agent.

Also, although the communication arrows were discussed in a certain order or illustrated in a sequence of communications, no particular ordering is required unless specifically state, or required because a communication is dependent on another communication being completed prior to the communication being transmitted.

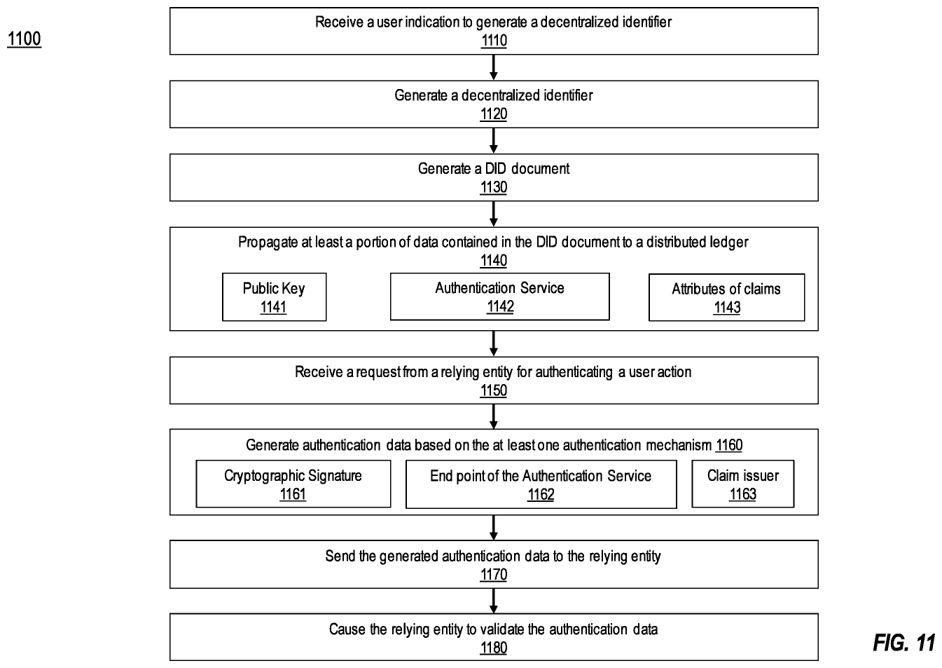

The following discussion now refers to a number of methods and method acts that are performed. FIG. 11 illustrates a flowchart of an example method 1100 for generating a DID that can be authenticated via one or more authentication mechanisms. The method 1100 is performed by a computing system that acts as a management module (e.g., a wallet app), a user agent, and/or an ID hub. The method 1100 includes receiving a user indication to generate a decentralized identifier (1110). The user indication includes a selection of at least one of a plurality of authentication mechanisms. The plurality of authentication mechanisms includes, but are not limited to, (1) a PKI, (2) an authentication service, (3) a self-issued claim, and/or (4) a verifiable claim.

In response to the user indication, the computing system generates a decentralized identifier (1120) and a corresponding DID document (1130). The computing system then propagate at least a portion of data contained in the DID document to a distributed ledger (1140). The DID document includes at least (1) data related to the DID, and (2) data related to the at least one authentication mechanism. In some embodiments, the data related to the DID is the DID or a hash of the DID. When the selected at least one authentication mechanism includes a PKI, the generating the decentralized identifier includes generating a key pair, including a private key and a public key. The generating the DID document includes recording the public key in the DID document. The propagating at least a portion of the data contained in the DID document to the distributed ledger includes recording at least data related to the public key in the distributed ledger (1141). In some embodiments, the data related to the public key is the public key; and alternatively, the data related to the public key is a hash of the public key, or any transformation of the public key that can be used to as a proof of or validate the public key.

In some embodiments, when the at least one authentication mechanism is an authentication service, the data propagated to the distributed ledger includes data related to the authentication service (1142). In some cases, the data related to the authentication service includes an identifier (e.g., DID) of the authentication service. In some embodiments, when the at least one authentication mechanism is a self-issued claim or verifiable claim, one or more attributes that are to be included in the claim is propagated to the distributed ledger (1143). For example, the one or more attributes may include email address.

The method 1100 further includes receiving a request from a verifying entity for authentication a user action (1150). For example, the user may be requesting a service provided by the verifying entity, and the verifying entity would like to know the identity of the user and also would like to verify that the person who acts on behalf of the user is, in fact, the DID owner. In response to the authentication request, the computing system generates authentication data based on the at least one authentication mechanism (1160).

In some embodiments, when the at least one authentication mechanism includes a PKI, the authentication data includes a cryptographic signature (1161). When the at least one authentication mechanism includes an authentication service, the authentication includes an endpoint of the authentication service (1162). In some cases, the endpoint of the authentication service is a URL referencing an endpoint of the authentication service for verifying a particular DID, as such, each URL corresponds to a particular DID. In some embodiments, when the at least one authentication mechanism includes a verifiable claim, the authentication data includes a claim issuer's identity (e.g., DID of the claim issuer) and/or the claim issued by the claim issuer (1163).

Next, the generated authentication data is sent to the verifying entity (1170), and the verifying entity is caused to validate the authentication data (1180) depending on the authentication mechanism(s) being implemented. Note, in some cases, the verifying entity does not necessarily require the subject's information to be verifiable, but only wants the subject entity to provide some information about itself. As illustrated in FIG. 8A, the verifying entity only needs the user to provide his/her name, phone number and zipcode. In such a case, the verifying entity can put the required information in the request, and the subject entity can include the response in the authentication data without implementing any authentication mechanism. Alternatively, the verifying entity can also request these information be authenticated via a cryptographic signature. In such a case, the subject entity will be required to attach a cryptographic signature at the end of the response at least to authenticate the response is generated by the owner of the DID.

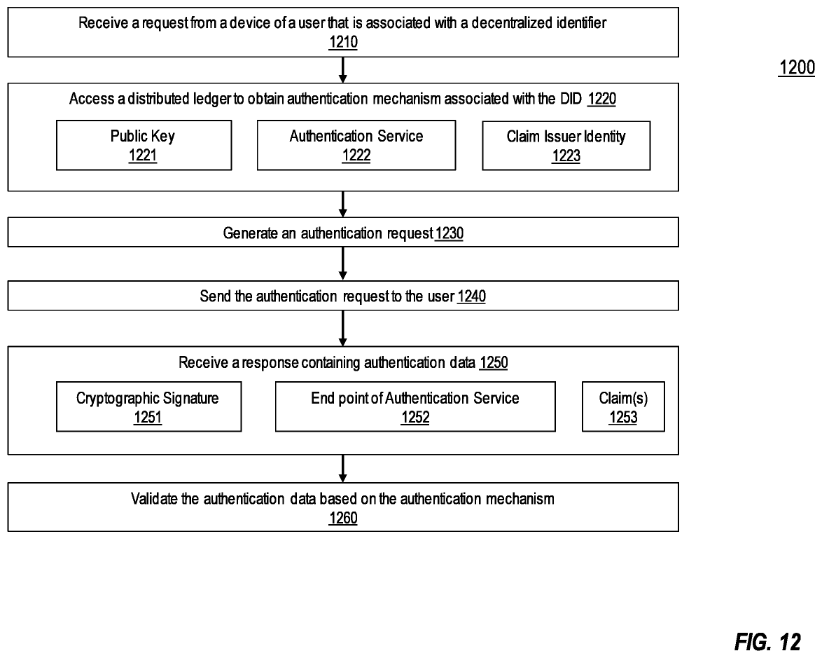

FIG. 12 illustrates an example method 1200 for authenticating a user associated with a DID. The method 1200 is performed by a verifying entity's computing system that acts as a service provider, a wallet app, a user agent, and/or an ID hub. The method 1200 includes receiving a request from a device of a user that is associated with a decentralized identifier (DID) (1210). Based on the DID of the user, the computing system accesses a distributed ledger to obtain data related to the authentication mechanism(s) associated with the DID (1220). In some embodiments, when the authentication mechanism(s) includes a PKI, the data related to the public key of the DID is obtained from the distributed ledger (1221). In some embodiments, when the authentication mechanism(s) includes an authentication service, data related to the authentication service is obtained (1222). In some embodiments, when the authentication mechanism(s) includes a verifiable claim, the claim issuer's identity is obtained (1223).

Based on the obtained authentication mechanisms, the computing system then generates an authentication request (1230). As illustrated in FIGS. 8A and 8B, depending on the authentication mechanisms, a different authentication request 800A or 800B is generated. The generated authentication request is then sent to the device of the user or an authentication service (1240). Receiving the authentication request, the authentication service or the device of the user generates a response including authentication data. The computing system then receives the response containing the authentication data (1250).

When the authentication mechanism(s) includes a cryptographic signature (1251), the authentication data is received from the device of the user, and the authentication data includes a cryptographic signature. When the authentication mechanism(s) includes an authentication service, the authentication data is received either from the device of the user or from the authentication service directly. The received authentication data may include an endpoint of the authentication service (e.g., a URL corresponding to the endpoint of the authentication service corresponding to the particular DID). In some embodiments, when the authentication mechanism(s) includes a verifiable claim, the authentication data includes the claim issuer's identity and the claim signed by the claim issuer.

Once the authentication data is received, the computing system then validates the authentication data based on the authentication mechanism used (1260). When the at least one authentication mechanism includes a PKI, the verifying entity will try to use a public key of the subject entity to decrypt the cryptographic signature. If the decryption result is valid, it indicates that the cryptographic signature was indeed generated by the owner of the DID, thus, the user action is valid. If the decryption result is invalid, it indicates that the cryptographic signature was not generated by the owner of the DID, thus, the user action is invalid. When the authentication is successful, the verifying entity will ultimately perform additional communications or actions to complete a requested transaction. When the authentication is not successful, the verifying entity will deny the request from the subject entity and/or notify the subject entity the denial.

For the processes and methods disclosed herein, the operations performed in the processes and methods may be implemented in differing order. Although the method acts may be discussed in a certain order or illustrated in a flow chart as occurring in a particular order, no particular ordering is required unless specifically stated, or required because an act is dependent on another act being completed prior to the act being performed. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to perform the following:
receive a user indication to generate a decentralized identifier, the user indication comprising selecting at least one of a plurality of authentication mechanisms;
in response to the user indication,
generate a decentralized identifier (DID);
generate a DID document, including at least (1) data related to the decentralized identifier and (2) data related to the selected at least one authentication mechanism; and
propagate at least a portion of data contained in the DID document to a distributed ledger.

2. The computing system of claim 1, the computing system further caused to perform the following:
receive a request from a verifying entity for authenticating a user action;
in response to the request, causing authentication data to be generated based on the at least one authentication mechanism; and
cause the generated authentication data to be sent to the verifying entity.

3. The computing system of claim 2, the authentication data being generate by at least one of the following: (1) the computing system, (2) a second computing system of the user, or (3) an authentication service.

4. The computing system of claim 2, the computing system further caused to perform the following:
cause the verifying entity to validate the authentication data based on the at least one authentication mechanism.

5. The computing system of claim 4, the plurality of authentication mechanisms comprising at least one of the following: (1) a public key infrastructure, (2) an authentication service, (3) a self-issued claim, or (4) a verifiable claim that is verifiable by a particular claim issuer.

6. The computing system of claim 5, when the selected at least one authentication mechanism includes a public key infrastructure,
the generating the decentralized identifier including generating a key pair including a public key and a private key,
the generating the DID document including recording the public key in the DID document, and
the propagating at least a portion of data contained in the DID document to the distributed ledger including recording at least data related to the public key in the distributed ledger.

7. The computing system of claim 6, the computing system further caused to perform the following:
in response to a request from the verifying entity to authenticate the user action, the generating authentication data including generating a cryptographic signature encrypted by the private key.

8. The computing system of claim 7, the causing the verifying entity to validate the authentication data based on the at least one authentication mechanism including:
causing the verifying entity to
retrieve the data related to the public key via the distributed ledger;
decrypt the cryptographic signature by the public key; and
in response to a valid decryption result, determine that the user's action is authenticated.

9. The computing system of claim 5, when the selected at least one authentication mechanism includes an authentication service,
the generating the DID document including recording data related to an identity of the authentication service in the DID document.

10. The computing system of claim 5, when the selected at least one authentication mechanism includes a self-issued claim or a verifiable claim,
the generating the DID document including recording at least one identity attribute that is required to be conveyed in the self-issued claim or the verifiable claim.

11. The computing system of claim 10, wherein the at least one identity attribute includes email address.

12. The computing system of claim 10, when the selected at least one authentication mechanism includes a verifiable claim,
the generating the DID document further including recording an identifier of the claim issuer that issues the verifiable claim.

13. The computing system of claim 12, wherein:
the claim issuer is associated with a DID, and
the identifier of the claim issuer includes a DID of the claim issuer.

14. A computing system comprising:
one or more processors; and
one or more computer-readable media having thereon computer-executable instructions that are structured such that, when executed by the one or more processors, cause the computing system to perform the following:
receive a request from a device of a user that is associated with a decentralized identifier (DID);
access a distributed ledger to obtain data related to the DID, the data related to the DID comprising at least one of a plurality of authentication mechanisms that can be used to authenticate the user;
based on the at least one authentication mechanism, generate an authentication request, requesting the user to prove that the user has control over the DID;
send the request to the device of the user;
receive a response containing authentication data; and
validate the authentication data based on the at least one authentication mechanism.

15. The computing system of claim 14, the response containing authentication data being generated from at least one of the following: (1) the device of the user, (2) a second device of the user, or (3) an authentication service.

16. The computing system of claim 14, the plurality of authentication mechanism comprising at least one of the following: (1) a public key infrastructure, (2) an authentication service, (3) a self-issued claim, or (4) a verifiable claim that is verifiable by a particular claim issuer.

17. The computing system of claim 16, when the at least one authentication mechanism includes a public key infrastructure,
the data related to the DID obtained from the distributed ledger including data related to a public key of the DID;
the received authentication data including a cryptographic signature signed by a private key corresponding to the public key of the DID; and
the validating the authentication data including
decrypting the cryptographic signature by the public key using the data related to the public key obtained from the distributed ledger; and
analyzing the decrypted signature to determine whether the authentication data is valid.

18. The computing system of claim 16, when the at least one authentication mechanism includes an authentication service,
the received authentication data including a URL referencing an endpoint of the authentication service;
the computing system further caused to:
communicate with the authentication service via the URL; and
receive an authentication result from the authentication service via the URL.

19. The computing system of claim 16, wherein when the at least one authentication mechanism includes a self-issued claim or a verifiable claim,
the data related to the DID comprises at least one identity attribute that is required to be conveyed in the self-issued claim or the verifiable claim;
the received authentication data includes the self-issued claim issued by the DID of the user or the verifiable claim issued by a claim issuer.

20. A method implemented at a computing system for generating and authenticating a decentralized identifier, comprising:
receiving a user indication to generate a decentralized identifier, the user indication comprising selecting at least one of a plurality of authentication mechanisms;
in response to the user indication,
generating a decentralized identifier (DID);
generating a DID document, including at least (1) data related to the decentralized identifier and (2) data related to the selected at least one authentication mechanism; and
propagating at least a portion of data contained in the DID document to a distributed ledger.
